(19) United States
(12) Patent Application Publication
(10) Pub. No.: US 2009/0008583 A1
(43) Pub. Date: Jan. 8, 2009

(54) Method for mounting a valve, and a valve

(75) Inventor: Marco Grethel, Buhlertal (DE)

Correspondence Address: ALFRED J MANGELS, 4729 CORNELL ROAD, CINCINNATI, OH, 452412433, US

(73) Assignee: Luk Lamellen und Kupplungsbau Beteiligungs KG, Buhl (DE)

(21) Appl. No.: 12/214,407

(22) Filed: Jun. 17, 2008

Related U.S. Application Data
(63) Continuation of application No. PCT/DE2006/002128, filed on Dec. 1, 2006.

(30) Foreign Application Priority Data
Dec. 17, 2005 (DE) 10 2005 060 565.6

(51) Int. Cl. F16K 31/08; B21D 51/16

(52) U.S. Cl. 251/65; 29/890.12

(57) ABSTRACT

A method for mounting a valve having a valve housing within which a valve spool is slidably received such that it can move to and fro. The position of the valve spool is detected by a sensor, in particular a Hall sensor, which interacts with at least one permanent magnet element or at least one magnetic flux element that is attached to the valve spool. Before the valve is put into operation, the valve spool is moved into at least one valve spool position that includes tolerances, and the spool position is detected and is accurately stored in a programmable sensor, and/or is programmed into the sensor.

### CROSS-REFERENCE TO RELATED APPLICATION

This is a continuation of International Application Serial No. PCT/DE2006/002128, having an international filing date of Dec. 1, 2006, and designating the United States, the entire contents of which is hereby incorporated by reference to the same extent as if fully rewritten.

### BACKGROUND OF THE INVENTION

The present invention relates to a method for mounting a valve having a valve housing within which a valve spool is slidably received such that it can move to and fro and the position of which is detected with the aid of a sensor device, in particular a Hall sensor device, which interacts with at least one permanent magnet element or at least one magnetic flux element that is attached to the valve spool. The invention also relates to a valve as described above.

An object of the present invention is to reduce the manufacturing and mounting costs of a valve having a valve spool.

### SUMMARY OF THE INVENTION

The object is achieved by a method for mounting a valve and by moving the valve spool, prior to placing the valve in service, into at least one valve spool position that is subject to tolerances. The valve spool position is detected exactly with a programmable sensor and is stored and/or programmed into the sensor. The use of a programmable sensor provides the benefit that complex and expensive mechanical adjustment of the sensor relative to the valve housing during mounting can be eliminated. Independent of manufacturing and assembly tolerances, certain output signals of the sensor can be associated with a corresponding valve spool position.

The object indicated above is achieved by a valve having a valve housing within which a valve spool is received such that it can move to and fro. The position of the valve spool is detected by a sensor, in particular a Hall sensor, which interacts with at least one permanent magnet element or at least one magnetic flux element that is attached to the valve spool. At least one valve spool position that is subject to tolerances and is detected exactly with a programmable sensor is programmed into the sensor and/or stored in the sensor. That provides the benefit that mechanical adjustment of the sensor at the final acceptance of the valve can be eliminated. Independent of production and assembly tolerances, in that certain output signals are associated with a corresponding valve spool position.

A preferred exemplary embodiment of the valve is characterized in that the valve spool is made of a magnetically impermeable material. The valve spool is made of aluminum, for example.

Another preferred exemplary embodiment of the valve is characterized in that at least the part of the valve housing in which the valve spool is received is made of a magnetically impermeable material. The valve housing is made of aluminum, for example.

Another preferred exemplary embodiment of the valve is characterized in that the permanent magnet element or the magnetic flux element is attached directly to the valve spool. The use of an adapter piece made of a magnetically impermeable material to receive the permanent magnet element or the magnetic flux element can be eliminated.

Another preferred exemplary embodiment of the valve is characterized in that the permanent magnet element or the magnetic flux element is connected with the valve spool by a flanged connection. Additional fastening devices are not needed.

Another preferred exemplary embodiment of the valve is characterized in that the valve spool has a central blind hole at one end, in which the permanent magnet element or the magnetic flux element is at least partially received. That enables a stable attachment of the permanent magnet element or the magnetic flux element to the valve spool in a simple manner.

Another preferred exemplary embodiment of the valve is characterized in that a flanged end is formed with the blind hole at the end of the valve spool. Before the flange formation, the flanged end has essentially the form of a round cylindrical sleeve that is situated coaxially to the longitudinal axis of the valve spool.

Another preferred exemplary embodiment of the valve is characterized in that the magnetic flux element has an attaching section that is received in the blind hole, and which is bounded by an annular groove. The annular groove serves to receive a flanged edge region of the valve spool.

Another preferred exemplary embodiment of the valve is characterized in that the permanent magnet element or the magnetic flux element has the shape of a ring that is slid onto one end of the valve spool and connected with it by a flanged connection. That enables a stable attachment of the permanent magnet element or the magnetic flux element to the valve spool in a simple manner.

### BRIEF DESCRIPTION OF THE DRAWING

Additional advantages, characteristics, and details of the invention are evident from the following description, in which various embodiments are described in detail with reference to the drawing. The drawing figures show the following:

FIG. 1 is a longitudinal cross section through a valve in accordance with a first exemplary embodiment of the present invention;

FIG. 2 is a fragmentary side view of an end of a valve spool, with an annular magnet situated radially within the valve spool end;

FIG. 3 is a fragmentary side view of an end of a valve spool, with an annular magnet situated radially outside on the valve spool end;

FIG. 4 is a fragmentary side view of an end of a valve spool, with a magnetic flux element that has an attaching section to which a circular disk is attached;

FIG. 5 is a fragmentary side view of an end of a valve spool with a circular-disk-shaped magnetic flux element; and

FIG. 6 is a fragmentary side view of an end of a valve spool with an annular magnet situated radially on the outside in accordance with another exemplary embodiment of the present invention.

### DESCRIPTION OF THE PREFERRED EMBODIMENTS

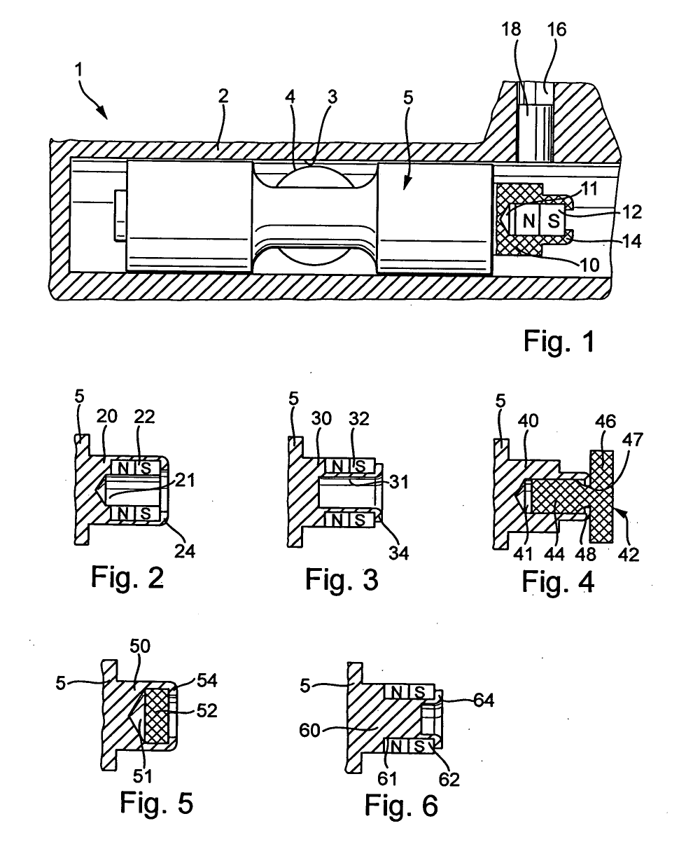

FIG. 1 shows a cross-sectional view of a valve 1. Valve 1 includes a valve housing 2 with a blind bore 3. In blind bore 3, which is preferably formed by a receiving bore, a valve spool 5 is slidably received so that it can move back and forth. Depending upon the position of valve spool 5 within blind bore 3, connections, such as, for example, the valve opening 4 between ducts or chambers, are disconnected and/or interrupted. Valve 1 is preferably a directional valve of a roll stabilization unit of a motor vehicle.

According to an essential aspect of the present invention, both valve housing 2 and valve spool 5 are made of a magnetically impermeable material, in particular aluminum. At one end of valve spool 5, a central extension 10 is connected to valve spool 5 as an integral piece. Extension 10 has a central blind bore 11, within which a substantially circular-cylinder-shaped permanent magnet 12 is received. Permanent magnet 12 is fixed in the blind bore by a flanged edge region 14, which emanates from extension 10.

Radially outside of the permanent magnet 12, a throughbore 16 extends in the radial direction in valve housing 2. A Hall effect sensor 18 is received in the throughbore 16. Hall effect sensor 18 is pressed or clamped, for example, in throughbore 16. That enables other fastening devices for fixing Hall effect sensor 18 in throughbore 16 to be eliminated.

According to another essential aspect of the invention, Hall effect sensor 18 is designed so that it is programmable. The programmability of Hall effect sensor 18 makes it possible for the various positions of the valve spool 5 in the valve housing 2 to be “learned” during acceptance of valve 1. Thus, the desired output signals when certain valve spool positions are reached can be programmed in, independent of manufacturing and assembly tolerances. That makes the processing of an analog output signal in an associated control device superfluous. The Hall effect sensor 18 can be accommodated in a hydraulics block.

FIGS. 2 through 6 show only the end of valve spool 5 having the central extension. The remainder of the valve spool 5 and the valve housing 2 are constructed the same as shown in FIG. 1.

In the exemplary embodiment shown in FIG. 2, the end of valve spool 5 has an extension 20 in which a central blind bore 21 is hollowed out. An annular permanent magnet 22 is situated in blind bore 21. Annular permanent magnet 22 is retained in blind hold 21 by an inwardly flanged end region 24 of extension 20.

In FIG. 3, the end of valve spool 5 has an extension 30 with a central blind bore 31. Radially outwardly of blind bore 31, an annular permanent magnet 32 is secured to extension 30 by a radially outwardly flanged end region 34.

In FIG. 4, an extension 40 with a central blind bore 41 is provided at the end of valve spool 5. A round, cylindrical attachment section 44 of a magnetic flux element 42 is received in the blind bore 41. Attachment section 44 is integrally connected to a circular disk 46, which extends outside of the blind bore 41 at the end of valve spool 5. Between the circular disk 46 and the attachment section 44, an annular groove 47 is formed that is engaged by a flanged end region 48 that extends radially inwardly from the extension 40.

In the exemplary embodiment shown in FIG. 5, a central extension 50 that includes a blind bore 51 extends from the end of valve spool 5. A substantially circular-cylinder-shaped magnetic flux element 52 is received in blind bore 51. Magnetic flux element 52 is retained in blind bore 51 by a radially inwardly extending flanged end region 54.

In the exemplary embodiment shown in FIG. 6, a central extension 60 extends from the end of valve spool 5. The extension 60 includes a radially-outwardly-extending step 61. An annular permanent magnet 62 is slid onto the step 61. The permanent magnet 62 is retained on the step 61 by a radially outwardly extending flanged end region 64.

1. A method for mounting a valve having a valve housing within which a valve spool is slidably received such that it can move to and fro, said method comprising the steps of: mounting a programmable Hall effect sensor on the valve housing adjacent to the valve spool; mounting at least one magnetic flux element on the valve spool; prior to placing the valve in service moving the valve spool into at least one valve spool position that is subject to tolerances; detecting the valve spool position exactly with the programmable sensor; and storing the detected valve spool position in the programmable sensor.

2. A valve comprising: a valve housing including a bore; a valve spool slidably received within the bore such that it can move to and fro; a Hall effect sensor mounted on the valve housing adjacent to the valve spool; at least one magnetic flux element carried by the valve spool, wherein at least one valve spool position that is subject to tolerances is exactly detected by the sensor and is stored in the sensor.

3. A valve in accordance with claim 2, wherein the valve spool is made of a magnetically impermeable material.

4. A valve in accordance with claim 2, wherein at least a part of the valve housing in which the valve spool is received is made of a magnetically impermeable material.

5. A valve in accordance with claim 2, wherein the magnetic flux element is attached directly to the valve spool.

6. A valve in accordance with claim 5, wherein the magnetic flux element is retained within the valve spool by a flanged connection.

7. A valve in accordance with claim 2, wherein the valve spool has a central blind bore on one end, within which the magnetic flux element is at least partially received.

8. A valve in accordance with claim 7, wherein a retaining flange is formed on the one end of the valve spool with the blind bore for engagement with the magnetic flux element.

9. A valve in accordance with claim 7, wherein the magnetic flux element includes an attachment portion that is received in the blind bore and is bounded by an annular groove.

10. A valve in accordance with claim 2, wherein the magnetic flux element is a ring that is slidably received on the one end of the valve spool and is retained on the valve spool by a flanged connection

11. A method in accordance with claim 1 wherein the magnetic flux element is a permanent magnet.

12. A valve in accordance with claim 2, wherein the magnetic flux element is a permanent magnet.
